(19) United States
(12) Patent Application Publication
(10) Pub. No.: US 2014/0173541 A1
(43) Pub. Date: Jun. 19, 2014

(54) Method and Apparatus for Verifying Debugging of Integrated Circuit Designs

(71) Applicant: CADENCE DESIGN SYSTEMS, INC., San Jose, CA (US)

(72) Inventor: David Guoqing Zhang, San Jose, CA (US)

(73) Assignee: CADENCE DESIGN SYSTEMS, INC., San Jose, CA (US)

(21) Appl. No.: 13/719,570

(22) Filed: Dec. 19, 2012

(51) Int. Cl. G06F 17/50

(52) U.S. Cl. CPC G06F 17/5045
USPC 716/107; 716/106

(57) ABSTRACT

Method and apparatus for verifying debugging aspects of integrated circuit (IC) designs. In one aspect, an IP provider(s) can use the same process that isolated IP defect(s) to demonstrate to the customer (whether an IC designer or an IP consumer such as a smartphone manufacturer) that the debugging was successful, and that errors in operation will not recur. In another aspect, the invention provides a facility that enables the IP provider to demonstrate to an IP consumer that a repaired IP component will work under a sufficiently broad set of circumstances, without that demonstration revealing the provider's proprietary IP to the consumer.

### CROSS-REFERENCE TO RELATED APPLICATION

The present application is related to commonly-assigned application Ser. No. ______, entitled “Method and Apparatus for Isolating and/or Debugging Defects in Integrated Circuit Designs,” Attorney Docket No. 13335/12045, filed on the same day as the present application. The contents of that related application are incorporated herein by reference.

### BACKGROUND

The present invention relates to integrated circuit designs, and in particular to techniques for verifying debugging of identified defects in such designs.

Integrated circuit (IC) designers do not always design every component of an IC. While IC designers may design one or more components of a particular IC, these designers often employ IC component designs (also known as intellectual property, or IP) from one or more third-party IP providers. Sourcing of IC component designs from third-party IP providers can facilitate overall design by avoiding the need for the IC designer to design every aspect of the IC's functionality. However, out-sourcing of IC component designs also can complicate debugging, because the origin of defects in the overall IC design can be unclear, for a variety of reasons.

When defects in IC component designs are encountered, an IC designer can do a data dump of the information of interest, and can analyze the data in order to identify the source of any defects. Where third-party IP providers are involved, it is desirable to place debugging responsibility with the third party who provided the functionality in question. The above-referenced copending application describes apparatus and techniques for facilitating the appropriate placing of that responsibility.

Once the appropriate IP provider takes responsibility for a defect and sets about to fix it, the provider must overcome various obstacles. Among these is potential ambiguity with respect to paths a finite state machine (one way of viewing an IC component or group of such components) might take to get to a particular state. There may be multiple paths, one or more of which might be the source of a defect. Just looking at an appropriate portion of a data dump might not resolve the ambiguity.

Once the defects are fixed, it is necessary for the IP provider to convince the IP consumer (which could be the IC designer, or the manufacturer of a device employing the IC) that the fix will work under a sufficient number of different circumstances. Consequently, it is desirable to input the repaired IP into a suitable test bench, and run appropriate scenarios, with combinations of input states, so as to demonstrate to the IP consumer that the fix will hold, without the IP provider revealing any of its proprietary IP in the course of the interaction with the IP consumer.

### BRIEF SUMMARY OF THE INVENTION

In view of the foregoing, it is one object of the present invention to provide a facility for enabling the IP provider to demonstrate to an IP consumer that a repaired IP component will work under a sufficiently broad set of circumstances, without that demonstration revealing the provider's proprietary IP to the consumer.

In accordance with one aspect of the present invention, a hardware verification system contains information that enables data tracing that is specific to a particular IP provider, based on IP specific tracing requirements, or IPSTRs, that the IP provider makes available. When the hardware verification system encounters defects, the system is able to use the IPSTRs to obtain data dumps that are specific to the component or components to which the IPSTRs relate. The IC designer need not be aware of the IPSTRs, so that no proprietary information need be made visible. Moreover, in one aspect the IP provider can provide IPSTRs without making proprietary information available.

IPSTRs also may have utility in a situation in which data streams are being generated which create ambiguity as to a source of a particular defect or defects. However, in this aspect of the invention, IPSTRs are not essential, particularly where the IP at issue is being provided in connection with implementation of a hardware or software standard.

In accordance with one aspect of the present invention, an IP provider, having debugged problematic code in an IP component, can demonstrate to the IC designer's satisfaction, without requiring going through verification, that the defect or defects have been repaired. Where a standard such as Bluetooth™, Wi-Fi, other communications, memory management, display, or other functionality in a device (e.g. a tablet, a smartphone, a notebook or desktop computer, or the like), is implicated, demonstration may be tied to a showing of compliance with the standard. Where the functionality in question is the result of proprietary third party IP which does not necessarily follow a particular standard, the IP provider may disclose IPSTRs which show the IC designer that the IP is functioning as intended, without the IP provider revealing its proprietary information.

### BRIEF DESCRIPTION OF THE DRAWINGS

FIG. 1 depicts a device having an IC with various IP design components.

FIG. 2 depicts a high level diagram of hardware and its connection over a network, to perform debugging and proof of efficacy thereof, in accordance with one aspect of the invention.

FIG. 3 depicts a flow chart in accordance with one aspect of the present invention.

FIGS. 4A and 4B depict examples of triggering environments and conditions in accordance with aspects of the present invention.

FIGS. 5A and 5B depict finite state machines in accordance with aspects of the present invention.

FIG. 6 depicts a flow of processing for demonstrating the viability of debugged IP, in accordance with one aspect of the present invention.

FIG. 7 depicts a high level block/flow diagram of processing that occurs in the debugging of IP.

### DETAILED DESCRIPTION

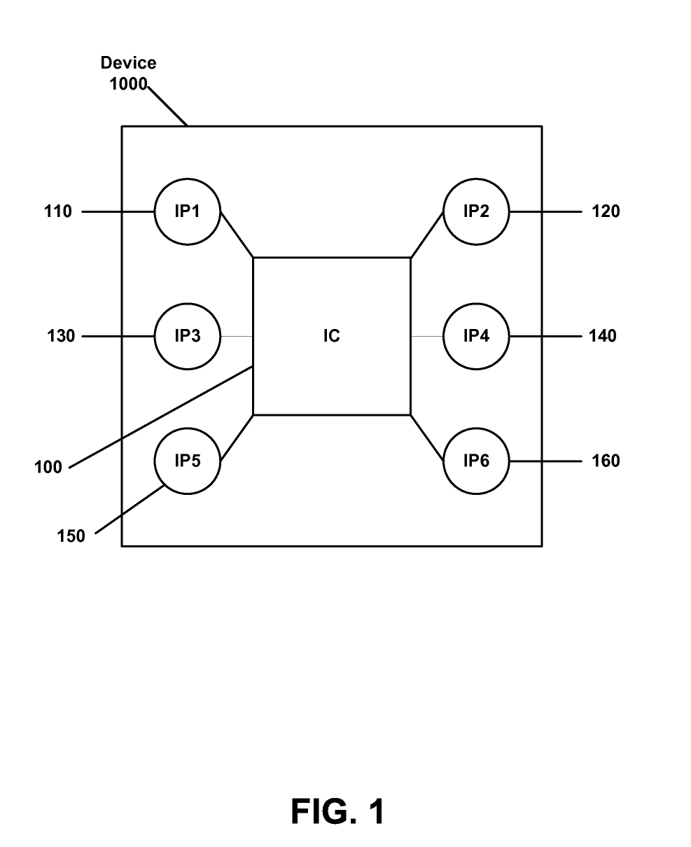

In FIG. 1, device 1000, which may be, for example, a mobile phone (including but not limited to a smartphone), a tablet, or a computer of some kind, includes one or more ICs 100 with IP design components IP1-IP6 labeled, for convenience, 110-160. Looking for example at a smartphone, a non-exhaustive list of IP design components could include memory (static or dynamic, general-purpose or special-purpose); display graphics; audio; video; power management; various wired communication and/or bus protocols including but not limited to PCI Express, members of the PCI Express family, and/or variants thereof, in different applications depending on the data communications need; wireless communications protocols including but not limited to cellular (e.g. GSM/CDMA), Bluetooth™, Wi-Fi (some form of 802.11), WIMAX (some form of 802.16); various connection protocols including but not limited to different forms of USB (different versions, micro-USB, mini-USB, and the like), video connection protocols (e.g. Thunderbolt (which might be one example of a PCI Express application), HDMI, or others) or other connector types which may or may not be proprietary; and/or image processing (e.g. on-board camera functionality). All of these various elements could be provided in a single IC (for example, in a system on a chip (SoC), or other IC incorporating IP from multiple providers, or multiple types of IP from a single provider), or could be contained in multiple ICs.

While some of the IP design components mentioned above may be proprietary, a number of them may be developed according to a standard, be it wired or wireless communications, audio, video, memory, or others. Different IP providers can and will have different ways of implementing a particular standard. Some of these IP design components may interrelate and/or interoperate. That is, some of these components may rely on performance of other components in order to function properly. For example, graphics processing may rely on special-purpose graphics memory, or additionally may rely on some portion of general purpose memory in order to perform in an optimal manner.

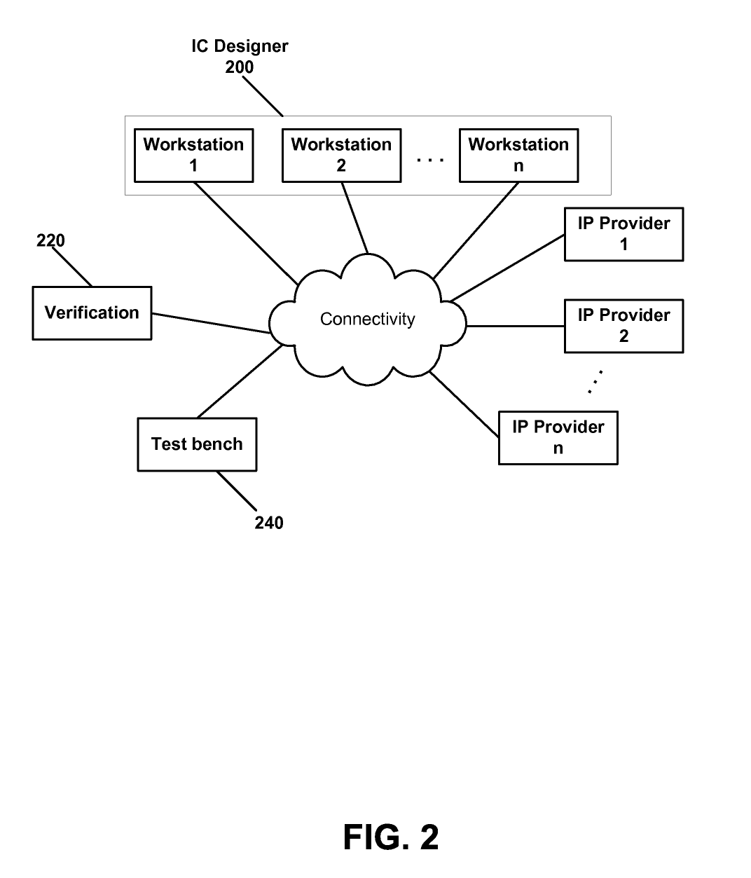

FIG. 2 depicts, at a high level, an environment in which an IC designer 200 (with design being carried out at any of one or more workstations 1, 2, . . . , n) may design an IC, test it through verification hardware and software 220, determine defect sources, and communicate the defect sources with the appropriate IP provider or providers selected from the group of n such providers shown in the Figure. In this way, the appropriate IP provider or providers can be informed of their responsibility for the defect(s), and then can perform the necessary debugging. The connectivity between an IC designer 200 and each IP provider 1-n is shown conceptually in one diagram here for convenience, but it should be understood that, in the usual case, IP providers would not be communicating directly with each other. The proprietary nature of what each IP provider may be providing to the IC designer would counsel against such connectivity. Rather, what is intended to be shown here is individual connectivity between an IC designer and each respective IP provider. Such connectivity may be local, or may be via the Internet, with or without secure communications between any of the workstations and a respective IP provider. The workstations need not be of any particular type, but should have the capability to run necessary electronic design automation (EDA) software and receive and implement design corrections. The blocks indicating the IP provider(s) may signify any number of types of workstations as well, so long as there is the capability to work on debugging of designs, and communicating the debugged designs appropriately to one or more of the other blocks shown. The IP provider's work to debug, and then to confirm with the customer that the debugging is complete (i.e. that the design works through an appropriately wide range of conditions), will be discussed in more detail below.

The verification block 220 and the test bench block 240 may be separate, as shown in FIG. 2, or may be together in a single station, or may be integral to one or more of the workstation and/or IP provider blocks depicted.

Each of the workstations referred to above may employ computer hardware of known types, including one or more processors, memory, and storage. All of these elements are well known to ordinarily skilled artisans, and may combined in any number of ways to effectuate defect isolation, attribution, and/or debugging according to aspects of the present invention. An exhaustive enumeration of the types and particular configurations of these elements is unnecessary to a proper understanding of the invention.

Verification and testing issues with respect to IP may arise in the following situation. For example, a smartphone manufacturer will want certain features and functionality in an SoC or other IC as described above, including memory management, graphics, image processing, and various forms of communications, among other things. As a result, the SoC/IC designer will incorporate different kinds of IP into the chip. Some of that IP may come from the smartphone manufacturer; in many cases, the IP will come from third party providers.

During testing, debugging invariably is necessary. When a problem is identified, it must be traced to its source, so that the entity that supplied the IP that caused the problem can fix it. However, because of the tremendous amount of data that gets input to and output from a chip, it can be very difficult to get a meaningful data dump to permit sufficient isolation of the problem source to convince the IP provider to take responsibility for fixing the problem.

Thus, it becomes necessary to present particular traffic patterns or signaling scenarios to the IP provider, so that the provider can reproduce the problem, and then fix it.

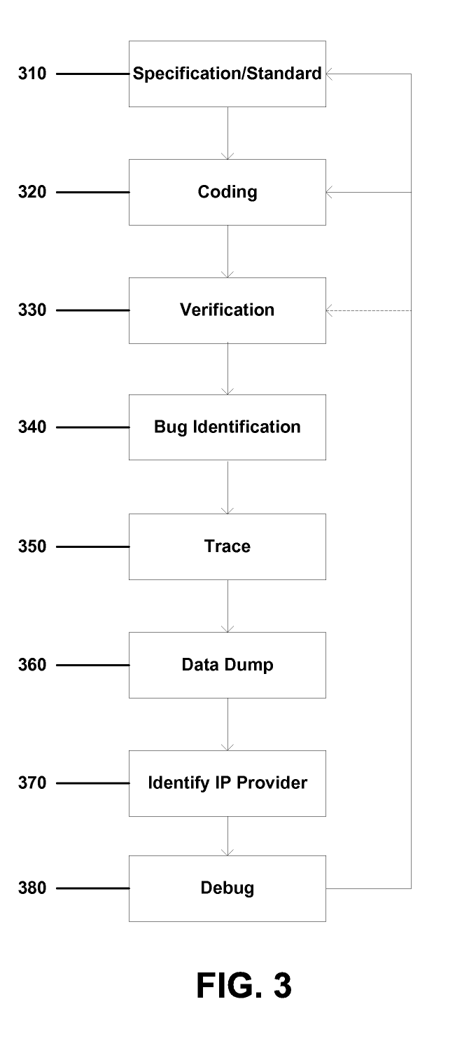

FIG. 3 shows a general flow of a debugging process that an IP provider and IP consumer will follow in working together to implement a particular type of IP in a device, perhaps in conjunction with an IC designer. In some instances, the IP consumer will be the IC designer, but for convenience, the IP consumer will be referred to alone. Initially, as shown at 310, the IP consumer will identify a specification or standard to be implemented in an IC. At 320, the IP provider will write code to implement the specification or standard. The code will be such that, once finalized, an IC fabricator will be able to take the code and lay out circuit paths and connections appropriately on a wafer.

At 330, the code that the IP provider has written may be implemented on an emulator, to verify that the coded circuitry will operate according to the specification or standard. In order to do this, the emulator will exercise the coded circuitry in numerous ways, to ensure that various input combinations do not result in erroneous or ambiguous results. Almost invariably, the emulation never runs properly the first time, and so there are errors. At 340, the errors or defects are identified, perhaps by identifying erroneous outputs or erroneous timing. Once the erroneous outputs or timing are identified, either a trace is captured (350) or a data dump performed (360), or both. The sequence in which these are performed is not critical to the invention. In one embodiment, capture of the trace at 350 enables more judicious selection of data to be dumped at 360. The trace will be discussed in more detail below.

With the trace captured and the data dump carried out, at 370 the IP provider can be identified. Debugging, which the IP provider then would perform, occurs at 380. Flow may return to 320, where further coding is performed and the remainder of the just-described steps repeated, or flow may return to 330, as indicated by the dotted line, where further verification may be performed. In some instances, the identified defect may come from the specification or standard itself, in which case flow may return to 310 instead of 320 or 330. Particularly where the IP provider is the originator of the specification or standard, when a bug is identified as related to that specification or standard, the specification or standard itself may be the source of the bug.

In FIG. 3, the flow appears endless, because defect identification follows verification in all instances. However, if verification uncovers no further defects, the process would stop.

Even when the IP provider takes ownership of the problem and fixes it, it is necessary for the IP provider to demonstrate to the SoC/IC designer, or to the ultimate customer (for example, the smartphone manufacturer), that the problem in fact is fixed, and will not recur. To do this, it is necessary to demonstrate operation of the repaired design under a number of different scenarios.

In order to ensure that a problem, once fixed, will not recur, it is important to take into account the possibility or probability that there may be different paths that a system (viewed in some respects as a finite state machine) may take to reach a certain state. The existence of these different paths can give rise to ambiguities, in which the IP provider, for example, may be able to recreate a state sequence resulting in a certain state, but still may not be able to verify that it was only that particular state sequence that yielded the result being observed.

As another part of this last aspect—proving that the defect will not recur—it is important to handle unpredictable behavior. While statistically, of course, the number of states, even in complicated systems, will be finite, though very large, there can be times when events like power disruptions or unusual actions by a user can place a system in an ambiguous state.

In one aspect of the invention, the ability of the verification equipment to employ dynamic triggering enables the setting of trigger conditions or to permit accounting for unpredictable behavior, including ambiguous states, in a design component. In an emulation, the dynamic triggering will prompt particular outputs which then may be monitored to see if they are as expected.

One way in which dynamic triggering may be effected involves the use of dynamic netlists. U.S. Pat. No. 7,379,861, incorporated herein by reference, describes dynamic netlists. A dynamic netlist can represent any type of logic or memory elements, such as combinational gates and state devices (e.g., registers) and may be used to define a trigger condition. Dynamic netlists can be loaded into an emulator and used to generate trigger signals when an IC design also is loaded into the emulator, so that the user can interact with the emulator irrespective of whether the design is presently being emulated.

As described in the above-mentioned patent, outputs of a dynamic netlist may be provided to trigger circuitry, which usually is fixed (i.e. is not changeable), and which outputs one or more trigger signals. The dynamic netlist determines the input or inputs to the fixed trigger circuitry, and so determines the outputs of that circuitry. Thus, together the dynamic netlist and the trigger circuitry constitute a dynamic trigger mechanism. In the context of a standard to be implemented, the dynamic trigger mechanism can provide standard-mandated inputs. The expected outputs from the IC design being emulated will be known from the standard. If there are bugs, then the outputs of the emulation will not be the expected outputs.

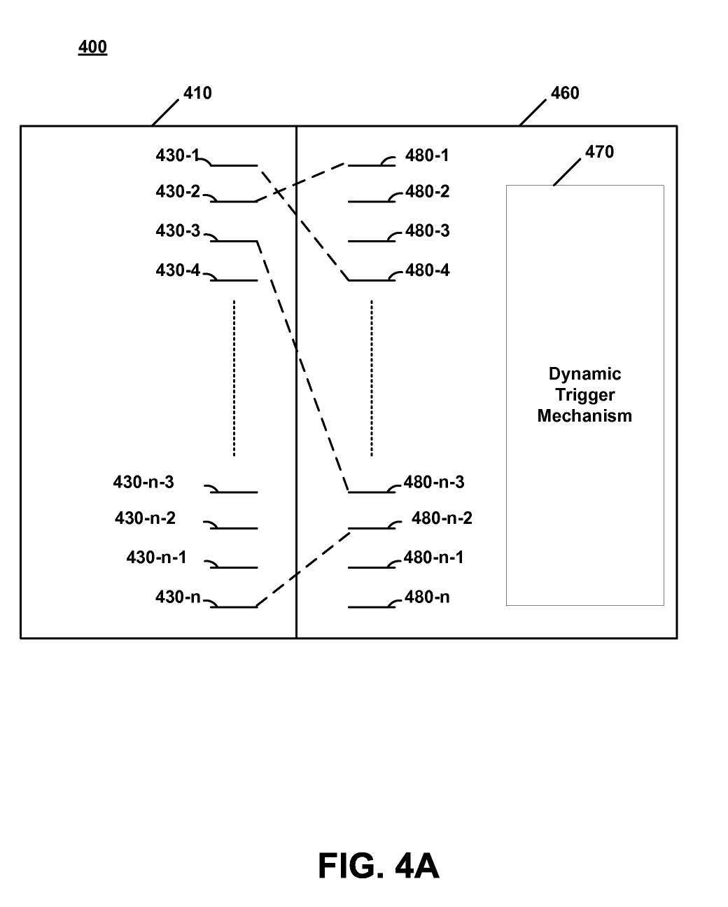

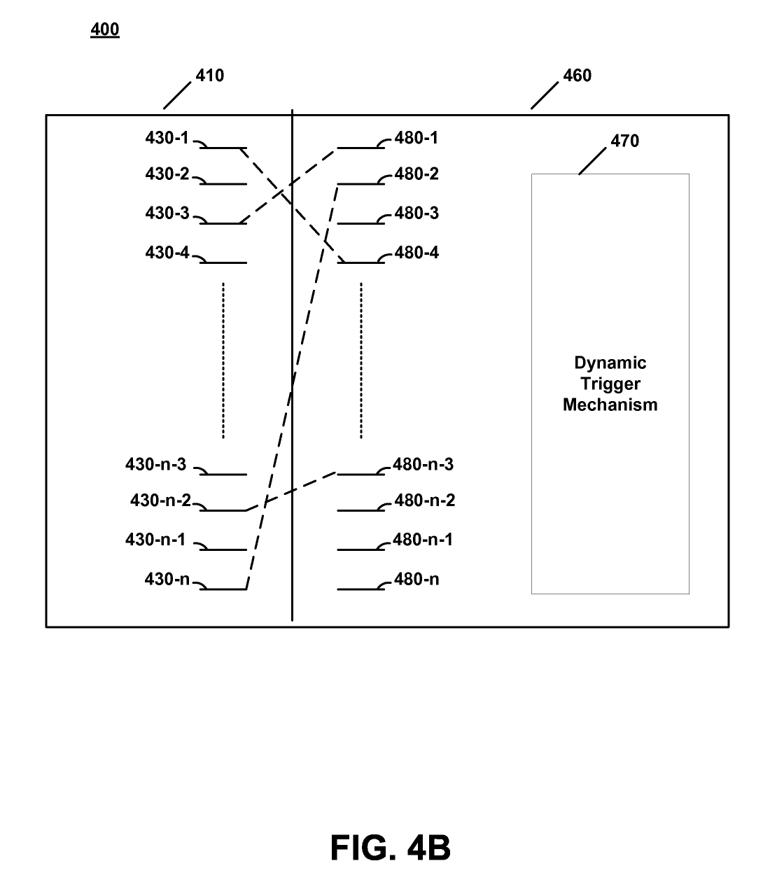

The just-discussed dynamic triggering capability, as part of an emulation, now will be discussed in more detail with respect to FIGS. 4A and 4B. FIG. 4A depicts two regions within a processing space. Region 410 on the left hand side of the Figure is a fixed region in which the IP from the provider may be stored and exercised. It is important that, during debugging, this IP not be disturbed. Rather, the exercise of the IP will be a function of preparation of a plurality of trigger conditions. The IP in this region 410 may be from a single provider, or may be from multiple providers. In either event, the process to be described will enable more specific identification of defects or, in the case of one aspect of the present invention, the attribution of the defects to particular IP, and hence to a particular IP provider or providers.

In FIG. 4A, lines 430-1, 430-2, 430-3, . . . , 430-n-2, 430-n-1, 430-n signify inputs to the IP in fixed region 410. By triggering different input combinations and monitoring outputs, it is possible to observe various aspects of behavior of the IP. A dynamic trigger mechanism of the type discussed above and/or as described in the above-mentioned patent may provide the inputs to the fixed region 410.

Region 460 on the right hand side of the Figure is a flexible or programmable region in the processing space. This region may contain the dynamic netlist referenced above, as part of dynamic trigger mechanism 470 depicted in the Figure and described above. In region 460, various trigger conditions may be set, through combinations of different inputs, via the dynamic trigger mechanism 480. Lines 480-1, 480-2, 480-3, . . . 480-m-2, 480-m-1, 480-m signify lines which, when connected in various ways to lines 430-1, etc. in region 410, will trigger different output signals and/or signal combinations, or different output line states.

A useful aspect of the flexible or programmable region 460 is that trigger conditions may be modified easily, in a dynamic fashion, through manipulation of conditions within the region 460, using the dynamic trigger mechanism 470. FIG. 4A shows one example of input combinations (via the dashed lines shown), while FIG. 4B shows a different configuration of dashed lines signifying another set of input combinations.

In the case of IP which is intended to comply with various aspects of a standard, the expected outputs largely will be known without requiring recourse to the IP provider. That is, a particular combination of inputs should yield standard-mandated outputs. The inputs may be inputs that are specified by the standard at issue. However, for purposes of identifying and resolving or avoiding potentially ambiguous states, for example, the inputs also usefully may vary from the standard, to account for unusual operating conditions. In a standards-based design, nonsensical outputs resulting from varying inputs may signify defects requiring correction.

It should be noted that there may be portions of a standard for which compliance is mandatory, and other portions for which compliance is optional. The IC designer, or the ultimate IP consumer (e.g. the smartphone manufacturer) may have a particular feature set in mind, in which compliance either with only mandatory portions of the standard, or with mandatory and certain optional portions of the standard, would be necessary. The IP provider will have received this information before designing the IP. The selection of mandatory and optional standards features may be proprietary to the IC designer or IP consumer, but need not be discernible from the IP provider's design.

In the case of IP that is designed to provide particular functionality, but in accordance with a proprietary design or feature set rather than a standard, outputs of the design will be a proprietary function of the inputs. An IP provider may be able to provide design-based sets of inputs and corresponding outputs (referred to earlier as IPSTRs), making it possible to exercise the design through selection of various combinations of inputs without revealing proprietary aspects of the IP design component. Again, it is possible to account for unusual operating conditions in emulated circuitry by programming region 460, using dynamic trigger mechanism 470, with input combinations that are different from what might occur in ordinary operation. In this fashion, it may be possible to identify ambiguous states.

As noted earlier, FIG. 4B is similar to FIG. 4A, except that there are different connections shown between the various lines 480-1 . . . 480-n on the programmable side and lines 430-1 . . . 430-n in the fixed region 410. Also as discussed, the different connections can provide a different trigger condition or set of trigger conditions. By monitoring the outputs of the IP in the fixed region 410, the portion or portions of the IP responsible for the defects can be identified.

As part of the process of exercising a circuit design, it is known in the electronic design automation art to use automatic test pattern generation (ATPG) to provide signal sequences and combinations to identify conditions under which the design will fail. ATPG also can provide signal sequences and combinations that may be applied to fabricated circuits to determine circumstances under which the circuits will fail. One potential problem with ATPG, however, is the sheer volume of data that is presented. As circuitry becomes more and more complex, with greater numbers of inputs and outputs, the number of possible outcomes makes the task of poring through a data dump daunting and time-consuming, in many cases excessively so.

In addition and as an alternative to ATPG techniques, however, the selection of particular signal sequences and combinations may be useful in isolating defects in IP, and in debugging and proof thereof. To this end, the dynamic triggering made possible in accordance with one aspect of the present invention can limit the amount of data that needs to be reviewed. In the case of a standards-based design, the signal sets are likely to be relatively small and manageable, so that triggering is straightforward. Even in the case of proprietary designs, IP providers may have in mind particular signal sequences that would be useful in exercising the design to isolate and/or identify defects.

The IP tracing capability enables an IP consumer to locate and identify a problem within the boundary of a particular IP provider. For example, there may be situations in which IP for a particular function, e.g. graphics, may come from more than one IP provider. Setting trigger conditions (e.g. particular sets or combinations of standard-mandated inputs) appropriately enables the IP consumer to isolate the signals which are involved in the particular problem, and thereby pinpoint the source as being one IP provider and not another.

In an instance in which the various IP providers—including in some cases the IP consumer—have IP which is proprietary, and the IP consumer is seeking to debug, the trace information need not include either the IP consumer's proprietary information, or the proprietary information of any of the IP providers.

In some instances, the verification IP implementation itself may produce errors or ambiguities. Here again, the tracing capability enables a user to navigate around, or avoid the error or ambiguities.

In another aspect of the invention, where the IP at issue is protocol-specific, for example, in accordance with a particular standard or group of standards, it may be possible to avoid having to share any IP provider-specific information, thus enabling the IP provider to keep its own implementation confidential.

In accordance with one aspect of the invention, an EDA manufacturer may receive IPSTRs and make them part of appropriate EDA software, be it verification IP as for example in verification block 220 in FIG. 2, or a test bench such as test bench 240 in FIG. 2, or some other EDA software. In some instances, the EDA manufacturer may be able to generate and/or implement the IPSTRs on its own. In general, in accordance with an aspect of the invention, IPSTRs for an IP provider can be generated without revealing the provider's proprietary information. When an IC designer encounters errors, and outputs a test stream using IPSTRs, the IP provider will better be able to determine what signals are in question, and what code might have caused erroneous output. The IPSTRs aid the IC designer, showing the outputs to the IP provider, in helping the provider verify that the provider's own IP is the source of the error(s).

Because the IC designer will not have direct access to the IPSTRs, the designer is not privy to the IP provider's proprietary information. The provider need not worry that sensitive aspects of the IP will leak out to competitors.

In accordance with another aspect of the invention, the design of ICs with functionality that operates according to one or more standards also facilitates debugging, in that the outputs associated with a particular function, e.g. 802.11 wireless, Bluetooth™, or the like, will have expected or anticipated behavior. If the outputs of the provider's code turn out not to be as expected, e.g. because the code does not handle particular inputs or timings, the provider's IPSTRs can use the outputs, or a comparison between the actual and expected outputs, and trace the erroneous signals back through various states, including in some cases ambiguous states, and isolate the defect(s) to a particular IP provider.

The IP for these various components may come from a single source, but more often they come from multiple sources. In some instances, for example with various flavors of USB, other serial, parallel connectors, or video connectors, design and operation of the associated IP may be fairly readily traceable to a particular source. Consequently, if for example a USB connection fails, the device developer may be able to trace the source fairly readily to the IP provider who provided the design component for the USB portion of the device. However, in circumstances where, for example, memory operation may be involved with both general purpose processing and special purpose (e.g. video and/or graphics) processing, a video processing failure may not be readily traceable to the IP provider(s) who provided the design component(s) for video processing. Alternatively, the failure may be traceable potentially to multiple IP providers, but it may be difficult to discern, simply from the data, which of those providers is responsible for the IP causing the failure.

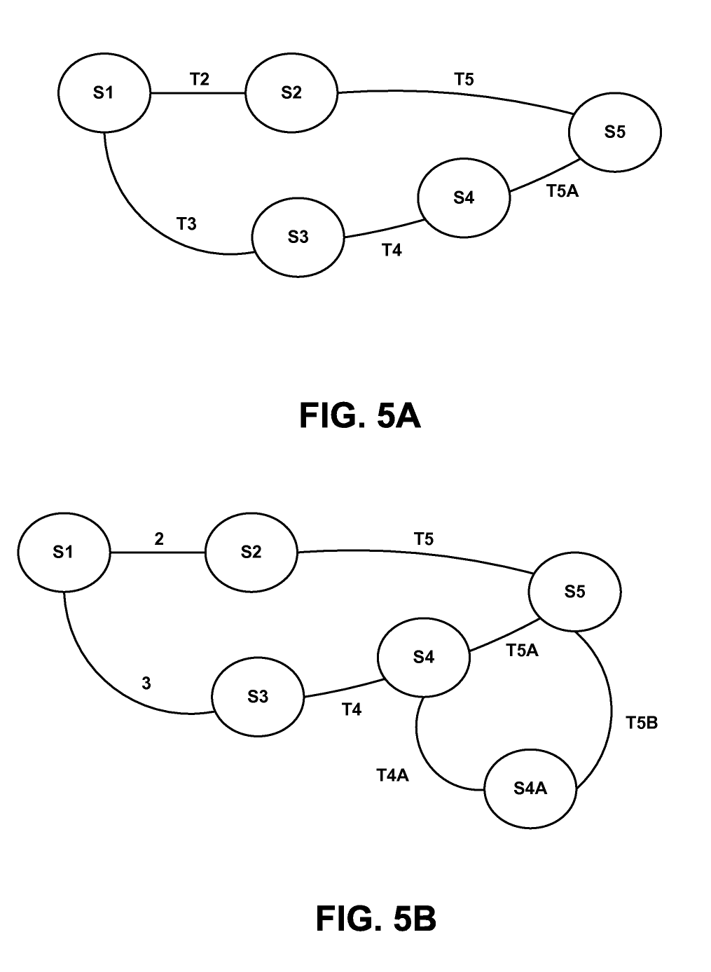

The approach described with respect to FIGS. 4A and 4B can be useful with respect to resolution of ambiguous states and ambiguous paths to particular states. FIGS. 5A and 5B show progressive states for a finite state machine, going from an initial state of S1 to a final state of S5 by different paths. Looking first at FIG. 5A, one path from S1 to S5 would be as follows: S1 to S2, via transition T2, to S5 via transition T5. Another path would be: S1 to S3 via transition T3, to S4 via transition T4, to S5 via transition T5A. It can be seen that, if the state S5 is erroneous, the cause could be, for example, either state S2 or transitions T2 and T5 in the first path; or state S3 or S4 in the second path, or any of transitions T3, T4, or T5A. If S2 results from IP from provider IP2 in FIG. 1, for example, and S3 results from IP from provider IP3 in FIG. 1, there can be two different sources of the erroneous state. Each IP provider could point back at the IC designer, or to the other IP provider, as the source of the error.

Even if S2 and S3 result from the same IP provider, there is ambiguity as to which IP from that provider would be the source of the error, so that the IP provider would have to undertake a substantial effort, poring through a substantial data dump potentially encompassing irrelevant conditions, in order to trace back through both state sequences to determine the source of the error.

In FIG. 5B, the situation is even more complicated by the provision of two potential paths from state S4 to state S5: One from S4 directly to S5 through transition T5A; and the other from S4 to S4A to S5 through transitions T4A and T5B. In this situation, there could be a still further IP provider implicated in the event of an erroneous state S5, and hence a further complication in identifying the IP provider responsible.

In accordance with one aspect of the invention, the ability to trace signals through different paths, and in particular, the ability to perform dynamic triggering in connection with particular states as shown in the state diagrams of FIGS. 5A and 5B, enable reliable identification of sources of erroneous states and/or signals in a design.

Even when the IP provider takes ownership of the problem and fixes it, it is necessary for the IP provider to demonstrate to the SoC/IC designer, or to the ultimate customer (the smartphone manufacturer), that the problem in fact is fixed, and will not recur. To do this, it is necessary to demonstrate operation of the repaired design under a number of different scenarios.

In order to ensure that a problem will not recur, it is important to take into account the possibility or probability that there may be different states through which a system may pass to reach a certain state, as exemplified in FIGS. 5A and 5B. The existence of these different paths can give rise to ambiguities, in which the IP provider, for example, may be able to recreate a state sequence resulting in a certain state, but still may not be able to verify that it was only that particular state sequence that yielded the result being observed. The IP provider's task may be yet more difficult because events like power disruptions or unusual actions by a user can place a system in an ambiguous state.

Once the IP provider has completed debugging the relevant portion of the IP responsible for errors, the IP provider needs to be able to test the debugged design. As noted earlier, it is known to use ATPG to provide a range of signaling scenarios, to exercise the debugged design and determine whether any defect recurs. However, there can be various problems with ATPG, including the volume of resulting data, and the potential generation of ambiguous states whose origins themselves may be ambiguous or otherwise hidden. In this event, the same techniques used to isolate and identify defects as described above may be applicable here. In particular, the trace or data dump that revealed a defect may be included or added for testing purposes. In one aspect, in the case of a standard-based IP component, the IP provider may program combinations of signals as indicated by mandatory and, where applicable, optional portions of the standard in region 460 in FIGS. 4A and 4B, using dynamic trigger mechanism 470, to verify the fix. In the case of a non-standard based IP component, the IP provider may program combinations of signals as indicated by IPSTRs, again using dynamic trigger mechanism 470.

Once the IP provider has tested the debugged design, it is necessary to demonstrate to the IP consumer that the debugged design works properly under a wide range of conditions. There are various ways to provide such a demonstration. In accordance with one aspect of the invention, the IP provider would use dynamic triggering as described above. Where in some circumstances circuit behavior can be unpredictable, dynamic triggering can be used to exercise the circuit design to demonstrate that the circuit is operating properly. Dynamic triggering can promote state changes in a finite state machine that would equate to unpredictable behavior, and thus exercise the design in a more limited manner that ATPG cannot. Another way to demonstrate correct operation is to conduct traces within the design, to show the origins of signal outputs. The ordinarily skilled artisan will understand that, depending on whether the IP provider is running a simulation or an emulation, traces based on setting of break points in code, or monitoring of outputs based on inputs that the dynamic triggering mechanism provides, may be appropriate for demonstrating IP component behavior.

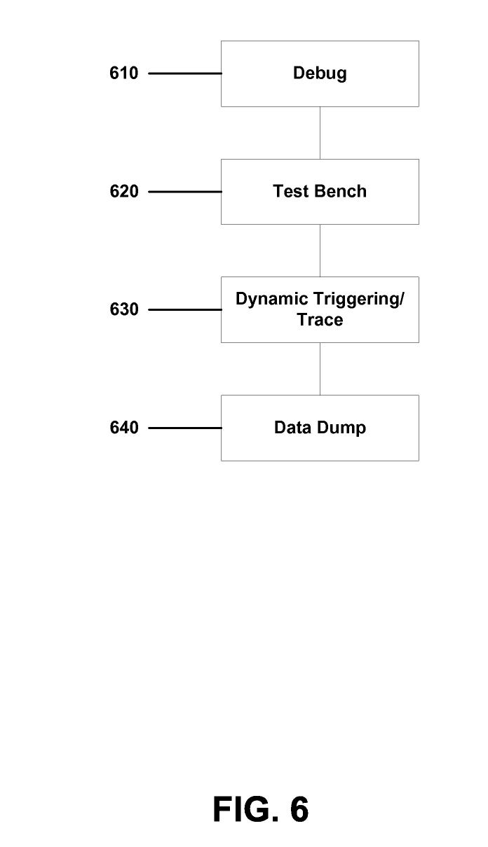

FIG. 6 depicts a high-level flow of the testing and demonstration that the IP provider may undertake. After debugging at 610, the IP provider may run an emulation of the circuit, using debugged design code, on a test bench at 620. While running on the test bench, the IP provider could employ ATPG, or any number of signal sequences to exercise the debugged design, though it should be understood that the employment of ATPG is not essential to the invention. At 630, perhaps as part of the exercising of the debugged design on the test bench, the IP provider may employ triggering of the type described above with respect to FIGS. 4A and/or 4B, to demonstrate to the IP consumer that the circuit design is operating properly. At 640, the IP provider may show the IP consumer a data dump of the information pertaining to inputs and outputs of the relevant portion of the design. The IP provider might step through the data with the IP consumer to satisfy the consumer as to the adequacy of the design's performance.

In the case of standards-based IP, the IP provider may provide a comparison of the outputs with standards-mandated outputs, based on the inputs provided by a trigger such as dynamic triggering mechanism 470 in FIGS. 4A and 4B. In the case of non-standards IP, the provider may present the IP consumer with outputs resulting from IPSTRs.

If the IP consumer is dissatisfied with the results, flow in FIG. 6 could return from 640 to 610 for further debugging. Once the IP consumer is satisfied, the flow in FIG. 6 would end.

In the course of convincing the IP consumer that the design works properly, the IP consumer may have its own verification setup to confirm the tests and data from the IP provider. However, in another aspect, the IP consumer may not have such a verification setup. In that event, there may be other tools at the IP consumer's disposal to verify the IP provider's claims, without resort to a verification setup.

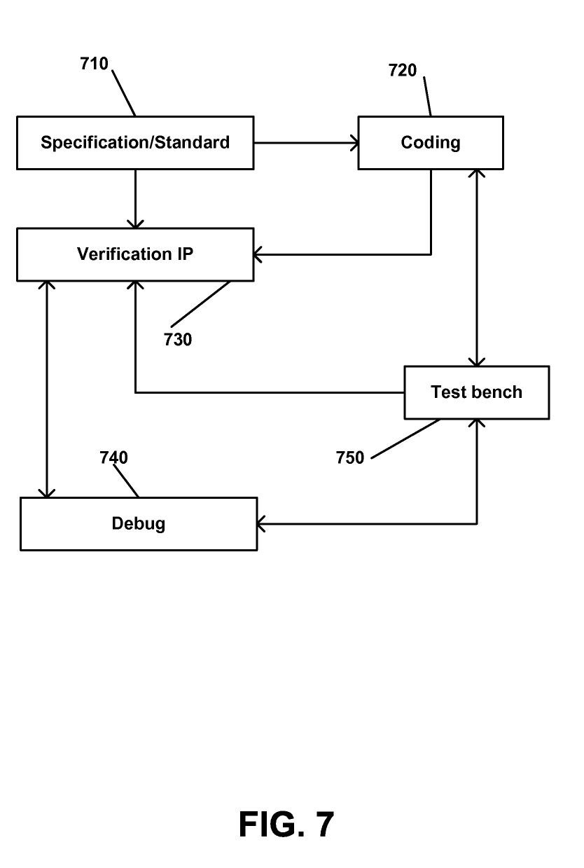

By way of overview or summary of the foregoing discussion, FIG. 7 depicts a high level diagram of interaction among various elements in an EDA system in accordance with one aspect of the invention. At 710, an IP consumer provides a specification (which may or may not be in accordance with a standard) for operation of a particular IP component (various types IP components were enumerated earlier). At 720, the IP provider codes the design, and at 730, the design is verified, and defects identified. Identified defects are dealt with at 740, and the resulting debugged design placed in a test bench at 750 for verification to the IP consumer that defects have been addressed.

The double arrows shown in FIG. 7 indicate potential iterations between and among certain of the elements, particularly between verification IP 730 and debug 740; between coding 720 and test bench 750; and between debug 740 and test bench 750. Not all of these iterations are necessary or essential, nor is any particular sequence of iterations necessary or essential. Among various possibilities, for example, running a debugged design on test bench 750 may reveal a need for further coding; hence the double arrow between coding 720 and test bench 750. Alternatively, running a debugged design on test bench 750 may reveal a need for further debugging; hence the double arrow between debug 740 and test bench 750. In circumstances in which an IP provider runs a debugged design through verification IP 730, further debugging may be indicated; hence the double arrow between verification IP 730 and debug 740.

In the foregoing discussion, there have been references to simulation as well as to emulation. Ordinarily skilled artisans will understand that the techniques described herein are applicable not only to emulations but also to simulations. Employing dynamic triggering in an emulator enables flexibility to provide the emulator inputs necessary to demonstrate that the emulator outputs, whether standards-based or proprietary, are correct. Employing break points at suitable places within a simulator, given the input combinations against which outputs are to be observed, likewise provides sufficient flexibility to demonstrate that the simulator values at those break points, whether standards-based or proprietary, are correct.

While particular embodiments of the present invention have been described, it is to be understood that various different modifications within the scope and spirit of the invention are possible. The invention is limited only by the scope of the appended claims.

1. A computer-implemented method of verifying debugging of an integrated circuit (IC) design component, the method comprising, after a procedure to debug an IC design defect:
a) using a processor to exercise the IC design component, without affecting the IC design component, by:
i) providing different predetermined combinations of inputs to the IC design component based on one of an identified industry standard or a third-party design;
ii) comparing resulting outputs to expected outputs based on either the identified industry standard or the third-party design;
wherein the inputs and expected outputs are generated from the identified industry standard or from information provided by the third party and are selected to identify defects in the IC design component;
the method further comprising:
b) if the resulting outputs are the same as the expected outputs, concluding that the debug procedure was successful; and
c) if the resulting outputs are different from the expected outputs, using a processor to initiate a new debugging procedure.

2. A computer-implemented method as claimed in claim 1, wherein a)i) comprises providing different predetermined combinations of inputs to the IC design component based on the identified industry standard.

3. A computer-implemented method as claimed in claim 1, wherein a)i) comprises providing different predetermined combinations of inputs to the IC design component based on the third-party design.

4. A computer-implemented method as claimed in claim 1, wherein a)ii) comprises comparing the resulting outputs to expected outputs based on the identified industry standard.

5. A computer-implemented method as claimed in claim 1, wherein a)ii) comprises comparing the resulting outputs to expected outputs based on the third-party design.

6. A computer-implemented method as claimed in claim 1, wherein the new debugging procedure comprises:
using a processor to identify an IC design defect; and
relating the IC design defect to the IC design component, wherein the relating comprises:
obtaining first data related to signals that the IC design component would output in normal operation;
using a processor to obtain second data related to signals that the IC design component output during a simulation or an emulation of operation of the IC design component;
analyzing the first and the second data to identify a correlation between the two; and
based on results of the analyzing, attributing a source of the IC design defect to the IC design component.

7. A computer-implemented method as claimed in claim 6, wherein the normal operation is operation according to the identified industry standard.

8. A computer-implemented method as claimed in claim 6, wherein the normal operation is operation according to the third-party design.

9. A computer-implemented method as claimed in claim 6, wherein using a processor to obtain second data comprises exercising the IC design component, without affecting the IC design component, by providing different combinations of inputs to the IC design component according to the identified industry standard.

10. A computer-implemented method as claimed in claim 6, wherein using a processor to obtain second data comprises exercising the IC design component, without affecting the IC design component, by providing different combinations of inputs to the IC design component according to the third party design.

11. Apparatus for verifying debugging of one or more defects in an integrated circuit (IC) design component, the apparatus comprising:
a memory; and
a processor programmed to:
a) exercise the IC design component, without affecting the IC design component, by:
i) providing different predetermined combinations of inputs to the IC design component based on one of an identified industry standard or a third-party design;
ii) comparing resulting outputs to expected outputs based on either the identified industry standard or the third-party design;
wherein the inputs and expected outputs are generated from the identified industry standard or from information provided by the third party and are selected to identify defects in the IC design component;
the processor further being programmed to:
b) if the resulting outputs are the same as the expected outputs, conclude that the debug procedure was successful; and
c) if the resulting outputs are the different from the expected outputs, initiate a new debugging procedure.

12. Apparatus as claimed in claim 11, wherein a)i) comprises providing different predetermined combinations of inputs to the IC design component based on the identified industry standard.

13. Apparatus as claimed in claim 11, wherein a)i) comprises providing different predetermined combinations of inputs to the IC design component based on the third-party design.

14. Apparatus as claimed in claim 11, wherein a)ii) comprises comparing the resulting outputs to expected outputs based on the identified industry standard.

15. Apparatus as claimed in claim 11, wherein a)ii) comprises comparing the resulting outputs to expected outputs based on the third-party design.

16. Apparatus as claimed in claim 11, wherein, to implement the new debugging procedure, the processor is further programmed to:
identify an IC design defect; and
relate the IC design defect to the IC design component by:
obtaining first data related to signals that the IC design component would output in normal operation;
obtaining second data related to signals that the IC design component output during a simulation or an emulation of operation of the IC design component;
analyzing the first and the second data to identify a correlation between the two; and
based on results of the analyzing, attributing a source of the IC design defect to the IC design component.

17. Apparatus as claimed in claim 16, wherein the normal operation is operation according to the identified industry standard.

18. Apparatus as claimed in claim 16, wherein the normal operation is operation according to the third-party design.

19. Apparatus as claimed in claim 16, wherein obtaining second data comprises exercising the IC design component, without affecting the IC design component, by providing different combinations of inputs to the IC design component according to the identified industry standard.

20. Apparatus as claimed in claim 16, wherein obtaining second data comprises exercising the IC design component, without affecting the IC design component, by providing different combinations of inputs to the IC design component according to the third party design.

21. A computer-implemented method as recited in claim 1, wherein the inputs and outputs are generated by EDA software that performs the debugging.
